(19) United States
(12) Patent Application Publication
(10) Pub. No.: US 2012/0010311 A1
(43) Pub. Date: Jan. 12, 2012

(54) BIODEGRADABLE TWO-LIQUID TYPE FOAMING COMPOSITION

(75) Inventors: Ching-Hsin Chang, Yulin County (TW); Wen-Chih Wu, Taichung City (TW)

(73) Assignee: WEI MON INDUSTRY CO., LTD., HSINCHU COUNTY (TW)

(21) Appl. No.: 13/259,153

(22) PCT Filed: Mar. 17, 2010
(86) PCT No.: PCT/CN2010/000324

§ 371 Date: Sep. 23, 2011

(30) Foreign Application Priority Data
Mar. 23, 2009 (CN) 200910127075.5

(51) Int. Cl. C08J 9/35; C08K 5/5419; C08K 3/34; C08K 3/26; C08K 3/36; C08G 18/66; C08L 1/28

(52) U.S. Cl. 521/109.1; 521/157; 521/110; 521/123

(57) ABSTRACT

A biodegradable two-liquid type foaming composition, which comprises main liquid and auxiliary liquid, is disclosed. The main liquid is formed by mixing polylactic acid powder, polycaprolactone polyol and foaming agent. The auxiliary liquid is formed by mixing polyol and isocyanate. Once the main liquid and the auxiliary liquid are mixed, the foaming reaction proceeds and the biodegradable foam is formed.

### CROSS-REFERENCE TO RELATED APPLICATION

This application claims priority to PCT Application No. PCT/CN2010/000324, filed Mar. 17, 2010, which claims priority to CN Application No. 200910127075.5, filed Mar. 23, 2009.

### BACKGROUND

1. Field of Invention

The present invention relates to a foaming composition. More particularly, the present invention relates to a biodegradable two-liquid type foaming composition.

2. Description of Related Art

Laminating, foaming, injection molding, foam molding (also known as injection molded foam) processes and the like are widely used to make plastics. In the foam molding processes, two-liquid type molded foam is the most common process. In general, after two types of liquids are forced to mix well, react, and yield a foamed product, the foamed product is put into a mold for forming foamed plastics. Such two-liquid foam molding technique can be used to produce foamed plastics rapidly and supply the needs of various industries.

However, due to the raising awareness of global environmental issues, many countries actively amend the laws for requiring the use of biodegradable plastics, and consumers become aware of reduction in use of non-degradable plastic products. Therefore, there are more traditional plastics replaced by biodegradable plastics currently.

Current biodegradable plastics have the same functionality of the traditional plastics. In addition, biodegradable plastics will be completely degraded in a short time by proper disposal. Even though they are disposed improperly, they can be decomposed into carbon dioxide and water by microorganisms because of their biodegradable property.

### SUMMARY

In one aspect of the present disclosure, a biodegradable two-liquid type foaming composition is provided. The biodegradable two-liquid type foaming to composition comprises a main liquid and an auxiliary liquid, in which a volume ratio of the main liquid to the auxiliary liquid is 1:1 to 10:1. The main liquid comprises 5 to 50 weight percent of polylactic acid powder, 45 to 90 weight percent of polycaprolactone polyol and 1 to 5 weight percent of foaming agent. The auxiliary liquid comprises a polyol compound and an isocyanate compound, and a molar ratio of cyanate group of the isocyanate compound to hydroxyl group of the polyol compound is 1.01 to 2.1.

In accordance with one embodiment of the present disclosure, the molecular weight of the polycaprolactone polyol of the main liquid is 900 Dalton.

In accordance with one embodiment of the present disclosure, the main liquid further comprises glycerol.

In accordance with one embodiment of the present disclosure, the foaming agent of the main liquid is a polylactic acid solution.

In accordance with one embodiment of the present disclosure, the polylactic acid solution comprises a polylactic acid, an emulsifying agent and an effective dose of water.

In accordance with one embodiment of the present disclosure, an amount of free cyanate groups in the auxiliary liquid is 3 to 29 weight percent.

In accordance with one embodiment of the present disclosure, the polyol compound is polycaprolactone polyol or ethylene glycol.

In accordance with one embodiment of the present disclosure, the molecular weight of the polycaprolactone polyol of the auxiliary liquid is 2000 to 3000 Dalton.

In accordance with one embodiment of the present disclosure, the isocyanate compound is diphenylmethane-4,4-diisocyanate, isophorone diisocyanate, tolylene diisocyanate, diphenylether diisocyanate, hexamethylene diisocyanate, methylcyclohexane diisocyanate, or dicyclohexylmethylmethane-4,4-diisocyanate.

In accordance with one embodiment of the present disclosure, the main liquid further comprises 0.1 to 0.3 weight percent of foam stabilizer.

In accordance with one embodiment of the present disclosure, the foam stabilizer is silicon oil.

In accordance with one embodiment of the present disclosure, the biodegradable two-liquid type foaming composition further comprises a filler.

In accordance with one embodiment of the present disclosure, the filler is silicon dioxide, mica powder, calcium carbonate, methyl cellulose or hollow glass powder.

In another aspect of the present disclosure, a biodegradable foam which is obtained by subjecting the foregoing biodegradable two-liquid type foaming composition to a foaming reaction is disclosed.

The main liquid and the auxiliary liquid in the present invention are prepared separately before subjecting to a foaming reaction, and both of them can be stored at room temperature. Moreover, components in the main liquid or the auxiliary liquid can be mixed first to prevent non-uniform mixing due to the different properties of each component.

These and other features, aspects, and advantages of the present invention will become better understood with reference to the following description and appended claims.

It is to be understood that both the foregoing general description and the following detailed description are by examples, and are intended to provide further explanation of the invention as claimed.

### DETAILED DESCRIPTION

According to one embodiment of this invention, a biodegradable two-liquid type foaming composition comprises a main liquid and an auxiliary liquid. The main liquid and the auxiliary liquid should be mixed to allow the foaming reaction to proceed.

The foregoing main liquid comprises polylactic acid powder, polycaprolactone polyol and a foaming agent. The polylactic acid and the polycaprolactone polyol are biodegradable polymers and the main reagents in the foaming reaction. The content of the polylactic acid powder of the main liquid is 5 to 50 weight percent.

The molecular weight of the polycaprolactone polyol of the forgoing main liquid is 900 Dalton. In one preferred example, the polycaprolactone polyol and glycerol are mixed first, and then the mixture is mixed with the polylactic acid powder and the foaming agent to form the main liquid. The content of the polycaprolactone polyol of the main liquid is 45 to 90 weight percent.

The foaming agent assists foaming reaction between the polylactic acid and the polycaprolactone polyol. The amount of the foaming agent determines the foaming level of the biodegradable two-liquid type foaming composition. The more the amount of the foaming agent is, the bigger the foam cell size will be. In one preferred example, polylactic acid solution is used to be the foaming agent. However, because hydrophilicity of polylactic acid is poor, forced emulsion method is employed to make polylactic acid be dispersed in aqueous solution. The polylactic acid solution utilized to be the foaming agent is prepared by polylactic acid, an emulsifying agent which assists increasing hydrophilicity of the polylactic acid, and an effective dose of water. The content of the foaming agent of the main liquid is 1 to 5 weight percent.

The foregoing auxiliary liquid comprises a polyol compound and an isocyanate compound, and the molar ratio of cyanate group of the isocyanate compound to hydroxyl group of the polyol compound is 1.01 to 2.1 for producing an alcohol prepolymer having excess cyanate group. The polyol compound may be polycaprolactone polyol or ethylene glycol. In one preferred example, the molecular weight of the polycaprolactone polyol which is utilized to produce the alcohol prepolymer is 2000 Dalton to 3000 Dalton.

Cyanate (—NCO) group in the isocyanate compound has chain extension and groups conversion functions that convert hydroxyl (—OH) group, carboxyl (—COON) group or amino (—NH) group. In one preferred example, cyanate group in the isocyanate compound is used to convert the hydroxyl group of polyol compound to cyanate group and perform chain extension reaction to form the alcohol prepolymer. The isocyanate compound may be diphenylmethane-4,4-diisocyanate, isophorone diisocyanate, tolylene diisocyanate, diphenylether diisocyanate, hexamethylene diisocyanate, methylcyclohexane diisocyanate, or dicyclohexylmethylmethane-4,4-diisocyanate.

The amount of free cyanate groups in the auxiliary liquid is 3 to 29 weight percent. The volume ratio of the main liquid to the auxiliary liquid in the foaming reaction depends on the content of free cyanate groups in the alcohol prepolymer. In one preferred example, a volume ratio of the main liquid to the auxiliary liquid is 1:1 to 10:1 for the foaming reaction.

According to one example in this invention, the main liquid further comprises 0.1 to 0.3 weight percent of foam stabilizer, such as silicon oil. If the main liquid contains more foam stabilizer, the foam density will be higher.

Also, the biodegradable two-liquid type foaming composition further comprises a filler. Adding the filler helps to increase strength and heat resistance of the foam obtained by subjecting the biodegradable two-liquid type foaming composition to the foaming reaction. The filler may be silicon dioxide, mica powder, calcium carbonate, methyl cellulose or hollow glass powder.

According to one embodiment of this invention, a biodegradable foam which is obtained by subjecting the foregoing biodegradable two-liquid type foaming composition to a foaming reaction is provided. The main liquid and the auxiliary liquid of biodegradable two-liquid type foaming composition are mixed and stirred at 3600 rpm to 15000 rpm by a high-speed stirrer. After mixing well, the product is subjected to a mold and dried at 60° C. to 90° C. by an oven for generating foamed plastics.

The foregoing biodegradable foam is capable of producing any kind of foamed products. As long as pour the biodegradable two-liquid type foaming composition into the desired mold, a variety of manufactured products can be made according to the mold shape. For example, sofa cushions, shoes and so on.

According to the embodiments of this invention, both of the main liquid and the alcohol prepolymer are liquid at room temperature and easy to be stored. The foaming reaction proceeds only when the two solutions are mixed together. Moreover, components in the main liquid or the auxiliary liquid can be mixed first to prevent non-uniform mixing due to the different properties of each component. In other words, components in the main liquid are mixed before the foaming reaction, and the polyol compound and the isocyanate compound of the auxiliary liquid are reacted first to form the alcohol prepolymer. The two reactions will not interfere with each other before the foaming reaction.

Although the present invention has been described in considerable detail with reference to certain embodiments thereof, other embodiments are possible. Therefore, their spirit and scope of the appended claims should no be limited to the description of the embodiments container herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A biodegradable two-liquid type foaming composition comprising:
a main liquid, wherein the main liquid comprises 5 to 50 weight percent of polylactic acid powder, 45 to 90 weight percent of polycaprolactone polyol and 1 to 5 weight percent of foaming agent; and
an auxiliary liquid, wherein the auxiliary liquid comprises a polyol compound and an isocyanate compound, and a molar ratio of cyanate group of the isocyanate compound to hydroxyl group of the polyol compound is 1.01 to 2.1, and
wherein a volume ratio of the main liquid to the auxiliary liquid is 1:1 to 10:1 in the biodegradable two-liquid type foaming composition.

2. The biodegradable two-liquid type foaming composition of claim 1, wherein the molecular weight of the polycaprolactone polyol of the main liquid is 900 Dalton.

3. The biodegradable two-liquid type foaming composition of claim 1, wherein the main liquid further comprises glycerol.

4. The biodegradable two-liquid type foaming composition of claim 1, wherein the foaming agent of the main liquid is a polylactic acid solution.

5. The biodegradable two-liquid type foaming composition of claim 4, wherein the polylactic acid solution comprises a polylactic acid, an emulsifying agent and an effective dose of water.

6. The biodegradable two-liquid type foaming composition of claim 1, wherein an amount of free cyanate groups in the auxiliary liquid is 3 to 29 weight percent.

7. The biodegradable two-liquid type foaming composition of claim 1, wherein the polyol compound is polycaprolactone polyol or ethylene glycol.

8. The biodegradable two-liquid type foaming composition of claim 7, wherein the molecular weight of the polycaprolactone, polyol of the auxiliary liquid is 2000 Dalton to 3000 Dalton.

9. The biodegradable two-liquid type foaming composition of claim 1, wherein the isocyanate compound is diphenylmethane-4,4-diisocyanate, isophorone diisocyanate, tolylene diisocyanate, diphenylether diisocyanate, hexamethylene diisocyanate, methylcyclohexane diisocyanate, or dicyclohexylmethylmethane-4,4-diisocyanate.

10. The biodegradable two-liquid type foaming composition of claim 1, wherein the main liquid further comprises 0.1 to 0.3 weight percent of foam stabilizer.

11. The biodegradable two-liquid type foaming composition of claim 10, wherein the foam stabilizer is silicon oil.

12. The biodegradable two-liquid type foaming composition of claim 1, further comprising a filler.

13. The biodegradable two-liquid type foaming composition of claim 12, wherein the filler is silicon dioxide, mica powder, calcium carbonate, methyl cellulose or hollow glass powder.

14. A biodegradable foam which is obtained by subjecting the biodegradable two-liquid type foaming composition of claim 1 to a foaming reaction.
